(19) United States
(12) Patent Application Publication
(10) Pub. No.: US 2025/0383626 A1
(43) Pub. Date: Dec. 18, 2025

(54) HOLOGRAM GENERATION METHOD, HOLOGRAM GENERATION APPARATUS, AND LIGHT IRRADIATION APPARATUS

(71) Applicant: HAMAMATSU PHOTONICS K.K., Hamamatsu-shi (JP)

(72) Inventors: Keisuke NISHIMURA, Hamamatsu-shi (JP); Taro ANDO, Hamamatsu-shi (JP); Hiroto SAKAI, Hamamatsu-shi (JP)

(73) Assignee: HAMAMATSU PHOTONICS K.K., Hamamatsu-shi (JP)

(21) Appl. No.: 19/206,352

(22) Filed: May 13, 2025

(30) Foreign Application Priority Data
Jun. 13, 2024 (JP) 2024-095763

(51) Int. Cl. G03H 1/08; G03H 1/16

(52) U.S. Cl. CPC G03H 1/0808; G03H 2001/0816; G03H 1/16

(57) ABSTRACT

A hologram generation method includes a pattern setting step, an intensity image calculation step, and an evaluation value calculation step. In the intensity image calculation step, zero padding is performed on a complex amplitude distribution acquired when a candidate pattern set in the pattern setting step is presented on an input plane, and a candidate intensity image is generated based on a result of a propagation calculation of the complex amplitude distribution after the zero padding. In the evaluation value calculation step, an evaluation value is obtained based on an intensity correlation between the candidate intensity image and a target intensity image. By using an optimization method, while changing the candidate pattern set in the pattern setting step, the respective steps are repeatedly performed, and any one candidate pattern is selected as a hologram to be presented on the input plane based on the evaluation value.

### CROSS-REFERENCE TO RELATED APPLICATION

This application is based upon and claims the benefit of priority from Japanese Patent Application No. 2024-095763, filed on Jun. 13, 2024, the entire contents of which are incorporated herein by reference.

### TECHNICAL FIELD

The present disclosure relates to a hologram generation method, a hologram generation apparatus, and a light irradiation apparatus.

### BACKGROUND

As a light irradiation apparatus, there is known an apparatus in which laser light is spatially modulated by a hologram which is presented on a spatial light modulator, and the laser light after the modulation is Fourier transformed by an optical system to perform light irradiation. In the light irradiation apparatus described above, in order to form a target intensity image having a desired intensity distribution by the light irradiation, it is important to present the hologram according to the target intensity image on the spatial light modulator.

An iterative Fourier transform algorithm (IFTA) is known as an algorithm for generating the hologram for forming the target intensity image. In the IFTA, the hologram according to the target intensity image is generated by repeatedly performing respective processes of Fourier transform calculation of a complex amplitude distribution of the light after the spatial modulation by the hologram, amplitude correction based on the target intensity image on the complex amplitude distribution obtained by the Fourier transform calculation, inverse Fourier transform calculation of the complex amplitude distribution after the amplitude correction, and correction of the hologram based on the complex amplitude distribution obtained by the inverse Fourier transform calculation.

A technique described in Non Patent Document 1 is also known as a technique for generating the hologram for forming the target intensity image. In the above technique, an evaluation value of a residual sum of squares type between an intensity image obtained by performing Fourier transform calculation of the complex amplitude distribution of the light after the spatial modulation by the hologram and the target intensity image is obtained, and the hologram is updated based on the evaluation value by using an optimization method. The evaluation value of the residual sum of squares type is an evaluation value based on a sum of a square of a difference of pixel values for each pixel between two images.

Non Patent Document 1: T. Harte, G. D. Bruce, J. Keeling and D. Cassettari, “Conjugate gradient minimisation approach to generating holographic traps for ultracold atoms”, Optics Express, Vol.22, No.22, pp.26548-26558, 2014

### SUMMARY

In each of the IFTA and the technique described in Non Patent Document 1, there is a limitation in generating the target intensity image of high resolution with high accuracy. For example, in the case in which the target intensity image is an image including a plurality of focusing regions (focusing spots), it is difficult to generate the target intensity image with high accuracy at a resolution close to the diffraction limit of light.

An object of an embodiment is to provide a hologram generation method and a hologram generation apparatus for generating a hologram capable of generating a target intensity image of high resolution with high accuracy. Further, another object of an embodiment is to provide a light irradiation apparatus capable of generating a target intensity image of high resolution with high accuracy.

An embodiment is a hologram generation method. The hologram generation method is a method for generating a hologram to be presented on an input plane in order to form a target intensity image on an output plane by optically propagating a complex amplitude distribution of light on the input plane, and includes (1) a pattern setting step of setting a candidate pattern to be a candidate of the hologram; (2) an intensity image calculation step of performing zero padding on a complex amplitude distribution acquired when the candidate pattern is presented on the input plane, and generating a candidate intensity image based on a result of a propagation calculation of the complex amplitude distribution after the zero padding; and (3) an evaluation value calculation step of obtaining an evaluation value based on an intensity correlation between the candidate intensity image and the target intensity image, and (4) by using an optimization method, while changing the candidate pattern set in the pattern setting step, respective processes of the pattern setting step, the intensity image calculation step, and the evaluation value calculation step are repeatedly performed, and any one candidate pattern is selected as a hologram to be presented on the input plane based on the evaluation value obtained in the evaluation value calculation step.

An embodiment is a program. The program is a program for causing a computer to execute the respective steps of the hologram generation method of the above configuration.

An embodiment is a recording medium. The recording medium is a computer readable recording medium recording the program of the above configuration.

An embodiment is a hologram generation apparatus. The hologram generation apparatus is an apparatus for generating a hologram to be presented on an input plane in order to form a target intensity image on an output plane by optically propagating a complex amplitude distribution of light on the input plane, and includes (1) a pattern setting unit for setting a candidate pattern to be a candidate of the hologram; (2) an intensity image calculation unit for performing zero padding on a complex amplitude distribution acquired when the candidate pattern is presented on the input plane, and generating a candidate intensity image based on a result of a propagation calculation of the complex amplitude distribution after the zero padding; and (3) an evaluation value calculation unit for obtaining an evaluation value based on an intensity correlation between the candidate intensity image and the target intensity image, and (4) by using an optimization method, while changing the candidate pattern set by the pattern setting unit, respective processes of the pattern setting unit, the intensity image calculation unit, and the evaluation value calculation unit are repeatedly performed, and any one candidate pattern is selected as a hologram to be presented on the input plane based on the evaluation value obtained by the evaluation value calculation unit.

An embodiment is a light irradiation apparatus. The light irradiation apparatus includes (1) the hologram generation apparatus of the above configuration; (2) a laser light source for outputting laser light; (3) a spatial light modulator for spatially modulating and outputting the laser light output from the laser light source based on the hologram generated by the hologram generation apparatus; and (4) an optical system for propagating a complex amplitude distribution of the laser light output from the spatial light modulator to form an image on the output plane.

According to the hologram generation method, the hologram generation apparatus, and the light irradiation apparatus of the embodiments, it is possible to generate a hologram capable of generating a target intensity image of high resolution with high accuracy.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram illustrating a configuration example of a light irradiation apparatus 1.

FIG. 2 is a diagram illustrating a configuration of a hologram generation apparatus 13.

FIG. 3 is a flowchart illustrating a hologram generation method.

FIG. 4A and FIG. 4B are diagrams showing a content of zero padding processing which is performed in an intensity image calculation step S2.

FIG. 5A and FIG. 5B are diagrams showing an effect of the zero padding processing which is performed in the intensity image calculation step S2.

FIG. 6A to FIG. 6C are diagrams each showing a hologram which is generated in a simulation, and show (A) a diagram showing the hologram generated in a first comparative example, (B) a diagram showing the hologram generated in a second comparative example, and (C) a diagram showing the hologram generated in an example.

FIG. 7A to FIG. 7C are diagrams each showing an image which is formed on an output plane in the simulation, and show (A) a diagram showing the image formed in the first comparative example, (B) a diagram showing the image formed in the second comparative example, and (C) a diagram showing the image formed in the example.

FIG. 8 is a diagram illustrating a configuration of an experiment optical system 2.

FIG. 9A to FIG. 9C are diagrams each showing an image which is formed on an output plane P2 in an experiment, and show (A) a diagram showing the image formed in the first comparative example, (B) a diagram showing the image formed in the second comparative example, and (C) a diagram showing the image formed in the example.

FIG. 10A and FIG. 10B are (A) a diagram showing an example of a phase distribution by a defocus aberration of an optical system 12, and (B) a diagram showing an example of an intensity image which is formed on the output plane P2 in the case in which the optical system 12 does not have an aberration.

FIG. 11A to FIG. 11C are diagrams each showing an example of the intensity image which is formed on the output plane P2 in the case in which the optical system 12 has an aberration.

FIG. 12 is a diagram showing images which are formed on the output plane in the simulation.

### DETAILED DESCRIPTION

Hereinafter, embodiments of a hologram generation method, a hologram generation apparatus, and a light irradiation apparatus will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

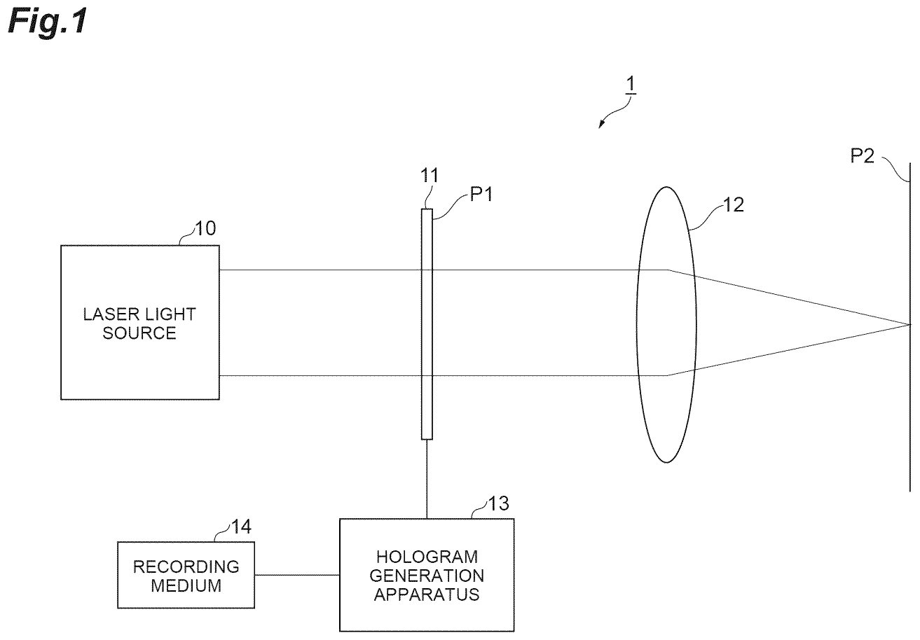

FIG. 1 is a diagram illustrating a configuration example of a light irradiation apparatus 1. The light irradiation apparatus 1 includes a laser light source 10, a spatial light modulator 11, an optical system 12, and a hologram generation apparatus 13.

The laser light source 10 outputs laser light with which the spatial light modulator 11 is illuminated. It is preferable that the laser light source 10 includes a beam expander for expanding a beam diameter of the light and collimating the light, and further, it is preferable that the laser light source 10 includes an aperture for selectively allowing the light in a beam center region out of the light having the expanded beam diameter to pass through and outputting the light. The laser light source 10 may be, for example, any one of a solid-state laser light source, a gas laser light source, a fiber laser light source, a semiconductor laser light source, and the like.

The spatial light modulator 11 presents a hologram which is generated by the hologram generation apparatus 13 on a modulation plane P1, spatially modulates the laser light output from the laser light source 10 on the modulation plane P1, and outputs the laser light after the modulation to the optical system 12. The optical system 12 optically propagates a complex amplitude distribution of the light after the modulation on the modulation plane (input plane) P1 of the spatial light modulator 11 to form an image on an output plane P2. Specifically, the optical system 12 forms the image on the output plane P2 by optically performing Fourier transform by a Fourier optical system or performing free propagation of the complex amplitude distribution after the modulation on the input plane P1.

The spatial light modulator 11 may spatially modulate both or either of an amplitude and a phase of the light. The spatial light modulator 11 may be a spatial light modulator of a transmission type, or a spatial light modulator of a reflection type. The spatial light modulator 11 may be, for example, any one of a liquid crystal type light modulator, an electro-optical modulator, an acousto-optical modulator, a digital mirror device, and the like.

The spatial modulation of the laser light on the modulation plane Pl of the spatial light modulator 11 is set by an electrical signal which is provided from the outside. The hologram is presented on the modulation plane Pl of the spatial light modulator 11. When the modulation plane Pl on which the hologram is presented is illuminated with the laser light, the complex amplitude distribution of the light after the modulation is obtained on the modulation plane P1. Further, the complex amplitude distribution described above is optically propagated through the optical system 12, and the image is formed on the output plane P2.

The hologram generation apparatus 13 generates the hologram to be presented on the modulation plane P1 of the spatial light modulator 11 in order to form a target intensity image on the output plane P2, and presents the generated hologram on the spatial light modulator 11. The hologram generation apparatus 13 stores a program for executing respective steps performed for generating the hologram.

The hologram generation apparatus 13 may be configured by using a computer including a processing unit such as a CPU, a GPU, and the like, and a storage unit such as a RAM, an HDD, an SSD, and the like. In the case in which the hologram generation apparatus 13 is configured by using the computer, the program for executing the respective steps is read out from the storage unit, and the program is executed by the processing unit to generate the hologram.

The program stored in the hologram generation apparatus 13 may be stored in the storage unit of the hologram generation apparatus 13 at the time of manufacture or shipment of the hologram generation apparatus 13, or the program acquired via a communication line after shipment may be stored in the storage unit of the hologram generation apparatus 13, or the program recorded in a computer readable recording medium 14 may be stored in the storage unit of the hologram generation apparatus 13. The recording medium 14 is an arbitrary medium such as a flexible disk, a CD-ROM, a DVD-ROM, a BD-ROM, a USB memory, or the like.

The target intensity image may be an arbitrary image, and for example, may be an image including one or a plurality of focusing regions (focusing spots) on the output plane P2. Further, the target intensity image may be an image in which a plurality of focusing regions (focusing spots) are regularly arranged in a lattice pattern on the output plane P2. The light irradiation apparatus 1 can be used for, for example, atom trap, laser processing, micro light pattern generation for microscopic observation, and the like, and generates the target intensity image according to the application.

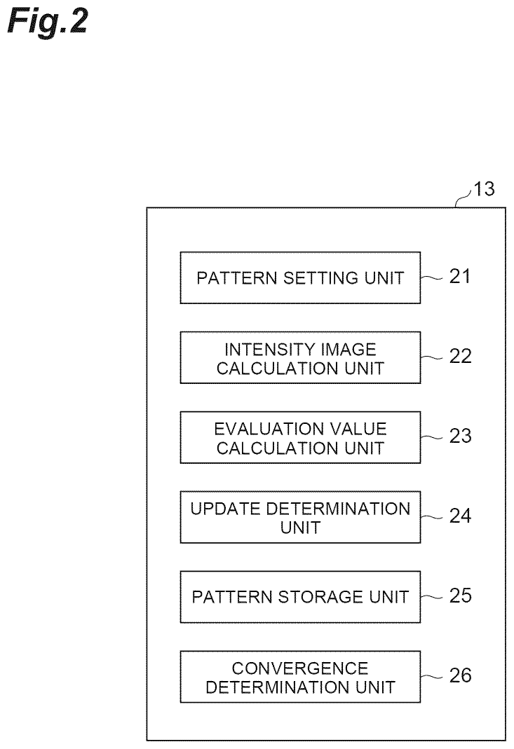

FIG. 2 is a diagram illustrating a configuration of the hologram generation apparatus 13. The hologram generation apparatus 13 includes a pattern setting unit 21, an intensity image calculation unit 22, an evaluation value calculation unit 23, an update determination unit 24, a pattern storage unit 25, and a convergence determination unit 26.

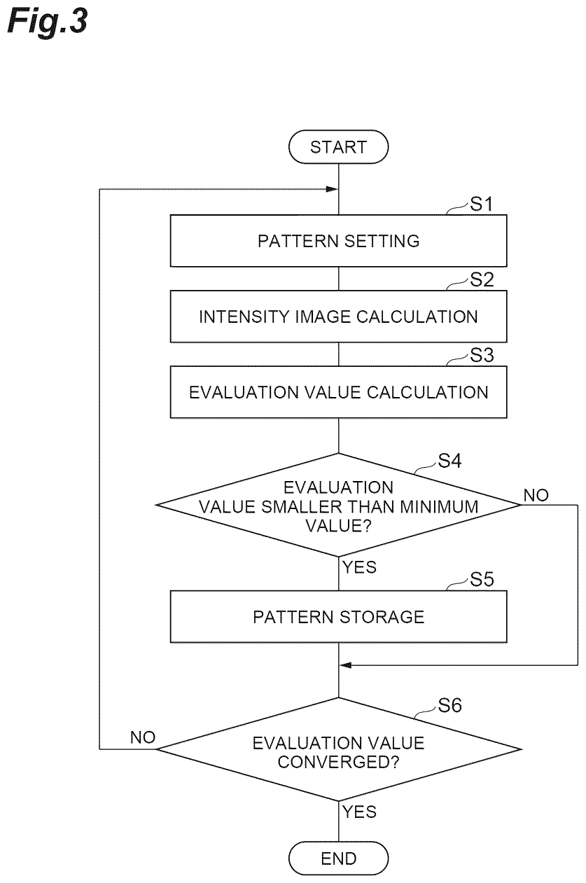

FIG. 3 is a flowchart illustrating a hologram generation method. The hologram generation method includes a pattern setting step S1, an intensity image calculation step S2, an evaluation value calculation step S3, an update determination step S4, a pattern storage step S5, and a convergence determination step S6.

The hologram generation method is a method for generating the hologram to be presented on the input plane Pl in order to form the target intensity image on the output plane P2 in the light irradiation apparatus 1, and the method is performed by the hologram generation apparatus 13. In the following description, it is assumed that the hologram which is presented on the input plane PI is a phase hologram.

In the pattern setting step S1, the pattern setting unit 21 sets a candidate pattern Φ(x, y) which is to be a candidate of the hologram presented on the input plane P1. The candidate pattern which is initially set by the pattern setting unit 21 may be a random pattern.

In the intensity image calculation step S2, the intensity image calculation unit 22 obtains, by the calculation, the complex amplitude distribution g(x, y) acquired by the laser light illumination in the case in which the candidate pattern Φ(x, y) is presented on the input plane P1 (the following Formula (1)), and performs zero padding on the complex amplitude distribution g(x, y). In addition, the intensity image calculation unit 22 performs a propagation calculation of the complex amplitude distribution g(x, y) after performing the zero padding to obtain a complex amplitude distribution h(p, q) on the output plane P2 (the following Formula (2)), and then generates a candidate intensity image I(p, q) on the output plane P2 (the following Formula (3)).

$$\begin{matrix}[ Formula 1 ] & \\ g ( x , y ) = a ( x , y ) \cdot exp ( i Φ ( x , y ) ) & ( 1 )\end{matrix}$$

$$\begin{matrix}[ Formula 2 ] & \\ h ( p , q ) = F [ g ( x , y ) ] & ( 2 )\end{matrix}$$

$$\begin{matrix}[ Formula 3 ] & \\ I ( p , q ) = {\vert h ( p , q ) \vert}^{2} & ( 3 )\end{matrix}$$

In the above formulas, i is an imaginary unit. x and y are variables indicating a position on the input plane P1. p and q are variables indicating a position on the output plane P2. a indicates an amplitude distribution due to a light intensity distribution in a beam cross section of the laser light which is input to the input plane P1.

In the evaluation value calculation step S3, the evaluation value calculation unit 23 obtains an evaluation value f based on an intensity correlation between the candidate intensity image I(p, q) and the target intensity image T(p, q) (the following Formula (4)). In this case, Iⱼ indicates a pixel value of a j-th pixel in the candidate intensity image I. Tⱼ indicates a pixel value of a j-th pixel in the target intensity image T. N_{I} indicates a normalization constant of the candidate intensity image I (the following Formula (5)). N_{T} is a normalization constant of the target intensity image T (the following Formula (6)). The evaluation value f can take a value of −1 or more and 0 or less.

$$\begin{matrix}[ Formula 4 ] & \\ f = - {\sum }_{j} \frac{{I}_{j} {T}_{j}}{{N}_{I} {N}_{T}} & ( 4 )\end{matrix}$$

$$\begin{matrix}[ Formula 5 ] & \\ {N}_{I} = \sqrt{{\sum }_{j} {I}_{j}^{2}} & ( 5 )\end{matrix}$$

$$\begin{matrix}[ Formula 6 ] & \\ {N}_{T} = \sqrt{{\sum }_{j} {T}_{j}^{2}} & ( 6 )\end{matrix}$$

In the update determination step S4, in the case of the first time, the update determination unit 24 stores the evaluation value f as a minimum value fₘᵢₙ, and proceeds to the pattern storage step S5. In the case of the second time or later, the update determination unit 24 compares a magnitude of the evaluation value f with a magnitude of the minimum value fₘᵢₙ. As a result of the above magnitude comparison, in the case in which it is determined that the evaluation value f is smaller than the previous minimum value fmin, the update determination unit 24 updates the storage with the evaluation value f as a new minimum value fₘᵢₙ, and proceeds to the pattern storage step S5. On the other hand, as a result of the magnitude comparison, in the case in which it is determined that the evaluation value f is equal to or larger than the previous minimum value fₘᵢₙ, the update determination unit 24 proceeds to the convergence determination step S6 without updating the minimum value fₘᵢₙ.

In the pattern storage step S5, the pattern storage unit 25 stores the candidate pattern Φ(x, y). The candidate pattern Φ which is stored in this case is the candidate pattern with which the evaluation value f of the minimum value until that time is obtained. After the candidate pattern is stored, the processing proceeds to the convergence determination step S6.

In the convergence determination step S6, the convergence determination unit 26 determines whether or not the evaluation value f has converged. In the case in which it is determined that the evaluation value f has not converged, the processing returns to the pattern setting step S1. In the case in which it is determined that the evaluation value f has converged, the processing is ended.

Until it is determined in the convergence determination step S6 that the evaluation value f has converged, the steps S1 to S6 are repeatedly performed while changing the candidate pattern Φ(x, y) to be set in the pattern setting step S1. In additon, the candidate pattern with which the evaluation value f of the minimum value is acquired by the end of the above processing is selected as the hologram to be presented on the input plane P1.

In the above repeated processing, an optimization method based on an arbitrary algorithm is used. Various algorithms are known as the optimization algorithm, and for example, a Nelder-Mead method, a simulated annealing method, a genetic algorithm, a Newton's method, a quasi-Newton method, a steepest descent method, a conjugate gradient method, and the like can be used.

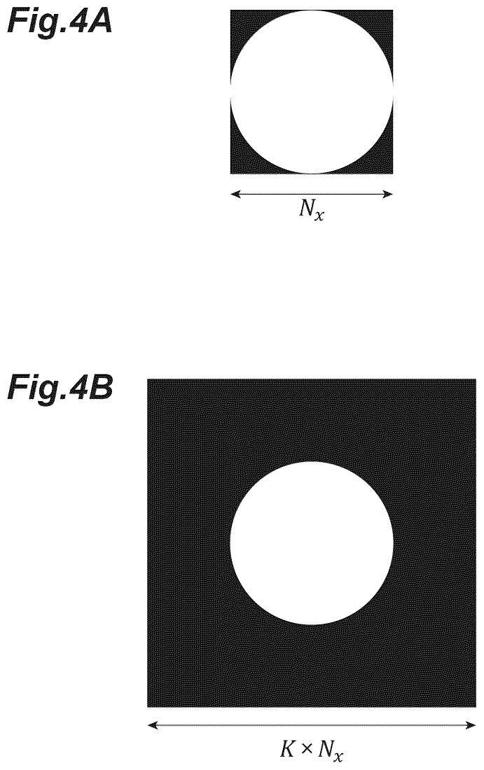

FIG. 4A and FIG. 4B are diagrams showing the content of the zero padding processing which is performed in the intensity image calculation step S2. The zero padding is the processing of adding pixels having a pixel value of 0 in a region around the original complex amplitude distribution (the complex amplitude distribution acquired by the laser light illumination when the candidate pattern Φ is presented on the input plane P1) to increase the number of pixels of the complex amplitude distribution. In the case in which the number of pixels is increased by K×K times by using the zero padding described above, it is expected that the resolution of the image formed on the output plane P2 is improved by K times. It is preferable that K is set to a value equal to or larger than 10.

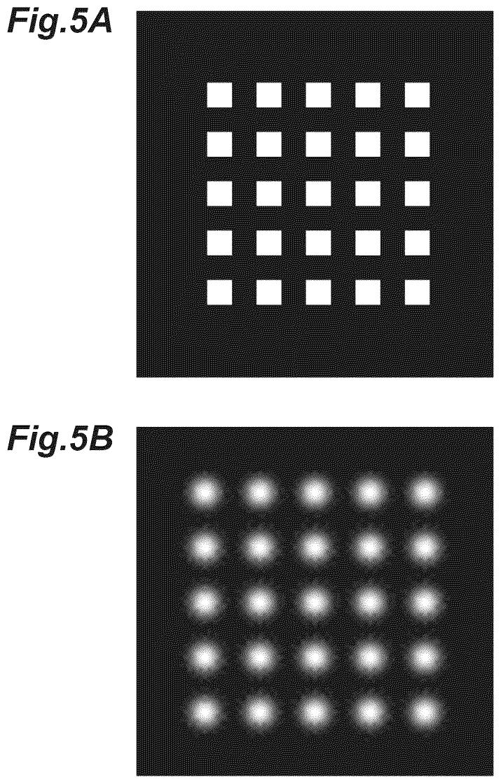

FIG. 5A and FIG. 5B are diagrams showing the effect of the zero padding processing which is performed in the intensity image calculation step S2. In this case, it is assumed that the target intensity image to be formed on the output plane P2 is the image in which 5×5 focusing regions are arranged in a square lattice pattern.

As shown in FIG. 5A, in the case in which the resolution of the image formed on the output plane P2 is low, each of the focusing regions in the image formed on the output plane P2 simply becomes a dot shaped bright point, and an intensity of the bright point can be evaluated, and further, a shape and an intensity distribution of the bright point cannot be evaluated.

On the other hand, as shown in FIG. 5B, in the case in which the resolution of the image formed on the output plane P2 is high, it is possible to evaluate the shape and the intensity distribution of each of the focusing regions in the image formed on the output plane P2. Therefore, it is expected that the target intensity image can be formed more accurately by increasing the number of pixels by performing the zero padding on the complex amplitude distribution before the propagation calculation.

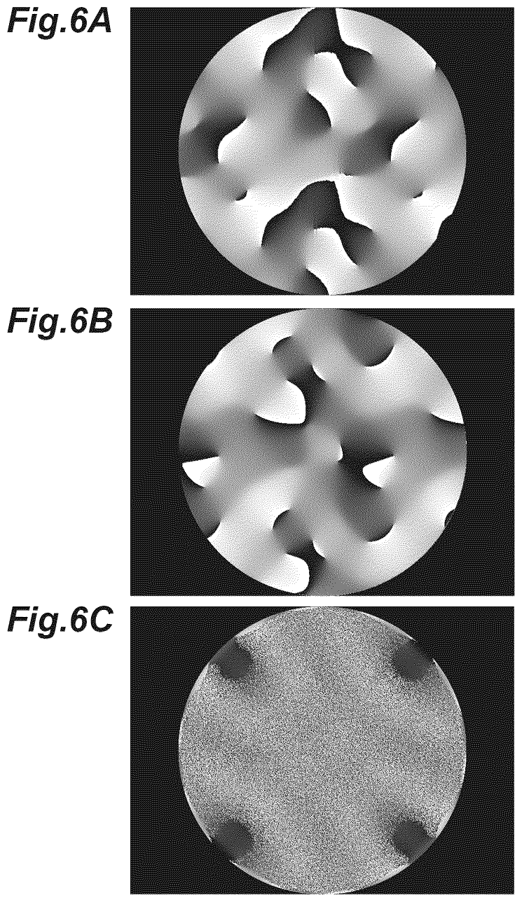

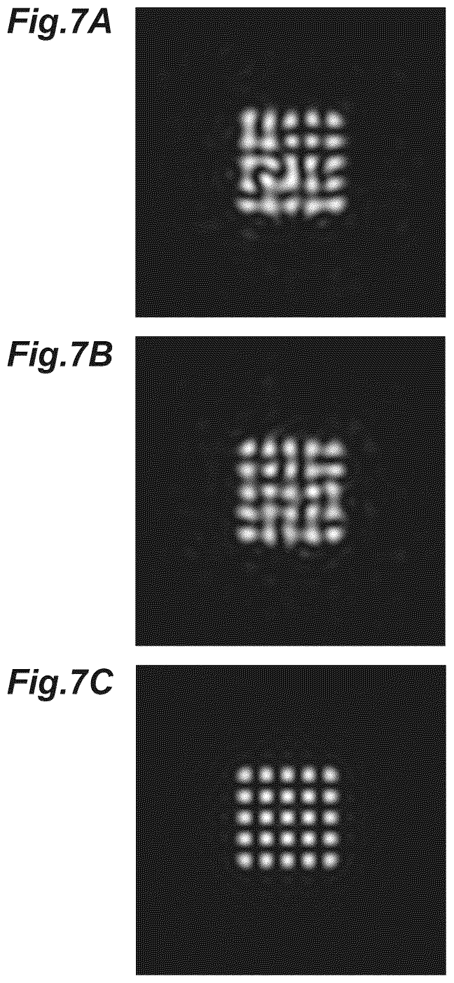

Next, simulation results will be described with reference to FIG. 6A to FIG. 6C and FIG. 7A to FIG. 7C. In this case, the target intensity image to be formed on the output plane P2 is set to the image in which the 5×5 focusing regions each having a circular shape are arranged in a square lattice pattern. The hologram is set to the phase hologram.

A case in which the hologram is generated by using the IFTA is set to a first comparative example, a case in which the hologram is generated by using the technique described in Non Patent Document 1 is set to a second comparative example, and further, a case in which the hologram is generated by using the hologram generation method according to the present embodiment is set to an example. Further, in the second comparative example and the example, a conjugate gradient method is used as the optimization method.

FIG. 6A to FIG. 6C are diagrams each showing the hologram which is generated in the simulation. FIG. 6A is a diagram showing the hologram generated in the first comparative example. FIG. 6B is a diagram showing the hologram generated in the second comparative example. FIG. 6C is a diagram showing the hologram generated in the example. In each of these diagrams, a phase distribution in the phase hologram is shown by grayscale. Further, in each of these drawings, a region in which the pixels are added by the zero padding is not shown.

As can be seen by comparing these diagrams, the hologram generated in the example (FIG. 6C) is significantly different from each of the holograms generated in the first and second comparative examples (FIG. 6A and FIG. 6B).

FIG. 7A to FIG. 7C are diagrams each showing the image which is formed on the output plane P2 in the simulation. FIG. 7A is a diagram showing the image formed in the first comparative example. FIG. 7B is a diagram showing the image formed in the second comparative example. FIG. 7C is a diagram showing the image formed in the example. In each of these diagrams, an intensity distribution in the image formed on the output plane P2 is shown by grayscale.

As can be seen by comparing these diagrams, in each of the images formed in the first and second comparative examples (FIG. 7A and FIG. 7B), there is a case in which a pixel having a certain light intensity is present between the adjacent focusing regions and the adjacent focusing regions are connected to each other, and further, the shape of each of the focusing regions is significantly distorted. On the other hand, in the image formed in the example (FIG. 7C), the respective focusing regions are formed independently of each other, and in addition, the distortion of the shape of each of the focusing regions is small.

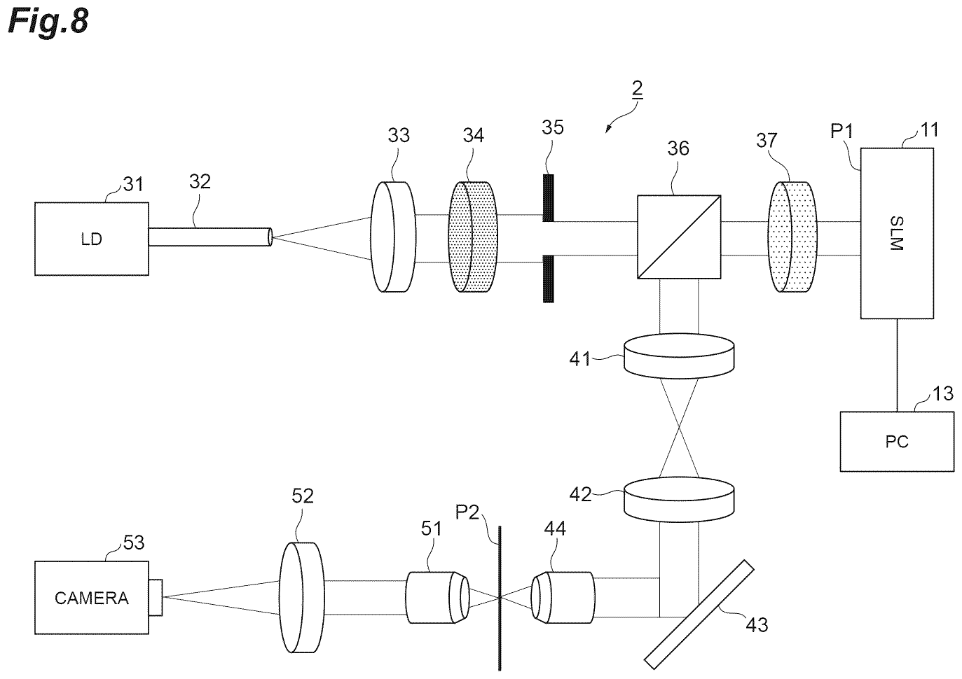

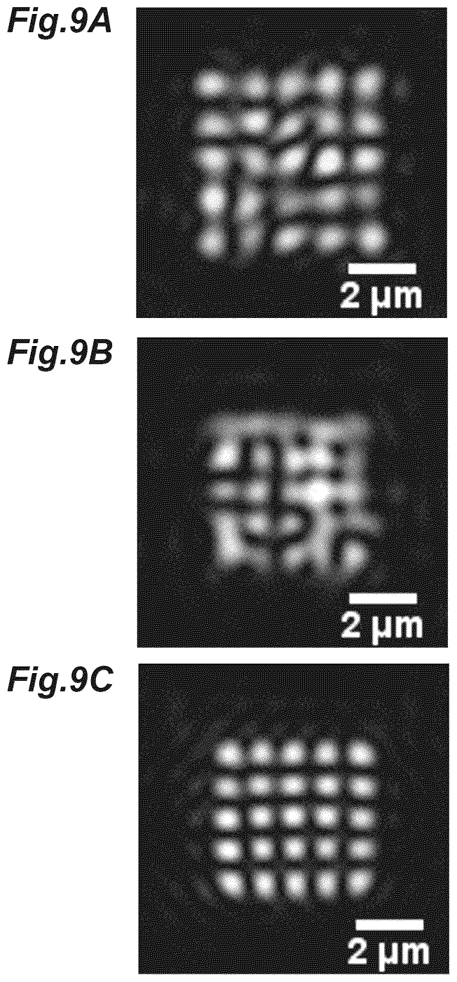

Next, experimental results will be described with reference to FIG. 8 and FIG. 9A to FIG. 9C.

FIG. 8 is a diagram illustrating a configuration of an experiment optical system 2. In the experiment optical system 2, laser light having a wavelength of 820 nm output from a laser diode 31, which is a semiconductor laser light source, is guided by a single mode optical fiber (an optical fiber) 32, and is output as diverging light from an output end face of the single mode optical fiber 32. The output end face of the single mode optical fiber 32 can be regarded as a point light source.

The laser light output from the output end face of the single mode optical fiber 32 is collimated by a lens 33, an intensity of the laser light is adjusted by an ND filter 34, and the laser light is input to an aperture 35. The light in a beam center region out of the laser light input to the aperture 35 passes through the aperture 35, and is input to a polarization beam splitter 36.

The light of the P-polarized light component out of the laser light which is input from the aperture 35 to the polarization beam splitter 36 is transmitted through the polarization beam splitter 36, and is input to the spatial light modulator 11 through a half wave plate 37. The laser light is incident on the spatial light modulator 11 on which the hologram generated by the hologram generation apparatus 13 is presented, and the laser light is spatially modulated by the hologram and reflected. In addition, in the above experiment optical system 2, the spatial light modulator 11 is a spatial light modulator of a reflection type for spatially modulating the phase of the light.

The laser light which is spatially phase modulated by the spatial light modulator 11 is input to the polarization beam splitter 36 through the half wave plate 37. The laser light is converted from the P-polarized light to the S-polarized light by passing through the half wave plate 37 twice. The laser light of the S-polarized light which is input from the half wave plate 37 to the polarization beam splitter 36 is reflected to a lens 41 by the polarization beam splitter 36. The laser light reflected by the polarization beam splitter 36 is relayed by the lens 41 and a lens 42, is reflected by a mirror 43, and is input to an objective lens 44. In addition, the modulation plane (the input plane) Pl of the spatial light modulator 11 and a pupil plane of the objective lens 44 are in an optically conjugate relationship with each other.

The laser light input to the objective lens 44 is strongly focused on the output plane P2 by the objective lens 44, and the image is formed on the output plane P2. In addition, the optical system from the spatial light modulator 11 to the output plane P2 corresponds to the optical system 12 provided in the configuration illustrated in FIG. 1. The image formed on the output plane P2 reaches an imaging plane of a camera 53 through an objective lens 51 and a lens 52. In addition, the output plane P2 and the imaging plane of the camera 53 are in an optically conjugate relationship with each other, and the image formed on the output plane P2 is captured by the camera 53. The image formed on the output plane P2 is magnified 60 times on the imaging plane of the camera 53 by the objective lens 51 and the lens 52, and the image is acquired.

FIG. 9A to FIG. 9C are diagrams each showing the image which is formed on the output plane P2 in the experiment. FIG. 9A is a diagram showing the image formed in the first comparative example. FIG. 9B is a diagram showing the image formed in the second comparative example. FIG. 9C is a diagram showing the image formed in the example.

In the first comparative example (the IFTA), the target intensity image to be formed on the output plane P2 is set to the image in which the 5×5 focusing regions each having a Gaussian distribution shape are arranged in a square lattice pattern with a pitch of 1.16 μm. Further, in the second comparative example (the technique described in Non Patent Document 1) and the example, the target intensity image to be formed on the output plane P2 is set to the image in which the 5×5 focusing regions each having a circular shape are arranged in a square lattice pattern with a pitch of 0.952 μm.

As can be seen by comparing these diagrams, even in the results of the experiment, in each of the images formed in the first and second comparative examples (FIG. 9A and FIG. 9B), there is a case in which a pixel having a certain light intensity is present between the adjacent focusing regions and the adjacent focusing regions are connected to each other, and further, the shape of each of the focusing regions is significantly distorted. On the other hand, in the image formed in the example (FIG. 9C), the respective focusing regions are formed independently of each other, and in addition, the distortion of the shape of each of the focusing regions is small.

As compared with the images formed in the first and second comparative examples, in the image formed in the example, the distortion of the shape of each of the focusing regions is kept small, and the lattice spacing can be made narrower while keeping the respective focusing regions separated from each other. As described above, in the example, it is confirmed that the target intensity image with high resolution close to the diffraction limit of the light can be generated with high accuracy.

Next, when the hologram is generated based on the evaluation value by using the optimization method, the case in which the evaluation value of an intensity correlation type is used as in the present embodiment, the case in which the evaluation value of an amplitude correlation type is used, and the case in which the evaluation value of a residual sum of squares type is used as in the technique described in Non Patent Document 1 will be described in comparison.

The evaluation value f of the intensity correlation type is represented by the above Formula (4) to Formula (6). The evaluation value f of the amplitude correlation type is represented by the following Formula (7) to Formula (9). The evaluation value f of the residual sum of squares type is represented by the following Formula (10).

$$\begin{matrix}[ Formula 7 ] & \\ f = - {\sum }_{j} \frac{\sqrt{{I}_{j} {T}_{j}}}{{M}_{I} {M}_{T}} & ( 7 )\end{matrix}$$

$$\begin{matrix}[ Formula 8 ] & \\ {M}_{I} = \sqrt{{\sum }_{j} {I}_{j}} & ( 8 )\end{matrix}$$

$$\begin{matrix}[ Formula 9 ] & \\ {M}_{T} = \sqrt{{\sum }_{j} {T}_{j}} & ( 9 )\end{matrix}$$

$$\begin{matrix}[ Formula 10 ] & \\ f = {\sum }_{j} {( {I}_{j} - {T}_{j} )}^{2} & ( 10 )\end{matrix}$$

The evaluation value of the correlation type may be used in some cases when the optimization is performed in the physics field or in the optics field. However, in general, the evaluation value of the amplitude correlation type with respect to the amplitude of the light (that is, the square root of the intensity) is used. The evaluation value of the amplitude correlation type is normalized by the square root of the sum of the intensities of the respective pixels (the above Formula (8) and Formula (9)). The above feature physically corresponds to the energy conservation law, and thus, it can be said that the evaluation value of the amplitude correlation type is a natural evaluation value. However, in the case in which the optimization is performed by using the evaluation value of the amplitude correlation type, the result is equivalent to the case in which the evaluation value of the residual sum of squares type is used.

Until now, in the context of performing the evaluation of the error in the optimization method, it has been common to use the evaluation value of the residual sum of squares type, and further, it has been considered that the above evaluation is sufficient. Further, as described above, it can be said that the evaluation value of the amplitude correlation type is a natural evaluation value, and on the other hand, the use of the evaluation value of the intensity correlation type as in the present embodiment means that the normalization is performed by the sum of the squares of the intensities of the respective pixels (the above Formula (5) and Formula (6)).

The evaluation value of the intensity correlation type is considered to be an unnatural evaluation value in the natural science field, in particular, in the physics field, and thus, there is little motivation to apply the evaluation value of the intensity correlation type. The present inventors have made intensive studies without being constrained by the technical common knowledge of those skilled in the art, and decided to use the evaluation value of the intensity correlation type when the hologram is generated by using the optimization method.

In addition, according to the findings of the present inventors, when the hologram is generated by using the optimization method, as compared with the case in which the evaluation value of the residual sum of squares type is used, in the case in which the evaluation value of the intensity correlation type is used, the resolution of the image to be formed is high (FIG. 6A to FIG. 9C), and on the other hand, the light use efficiency is low. The light use efficiency is a ratio of the light intensity used on the output plane with respect to the incident light intensity on the hologram, and is calculated as the light intensity in the region of interest/the incident light intensity.

For example, in the case in which the image in which the 5×5 focusing regions are arranged in a square lattice pattern is formed, the light use efficiency in the case in which the evaluation value of the residual sum of squares type is used is 0.928 in the simulation and 0.64 in the experiment, and on the other hand, the light use efficiency in the case in which the evaluation value of the intensity correlation type is used is 0.120 in the simulation and 0.127 in the experiment. The present embodiment which is performed by using the evaluation value of the intensity correlation type in generating the hologram by using the optimization method is the technique in order to achieve high resolution and high accuracy of the image at the expense of the light use efficiency.

Next, improvement of robustness of the hologram will be described. In the case in which the optical system 12 between the input plane Pl and the output plane P2 has an aberration, a distorted image is formed on the output plane P2 due to the effect of the aberration.

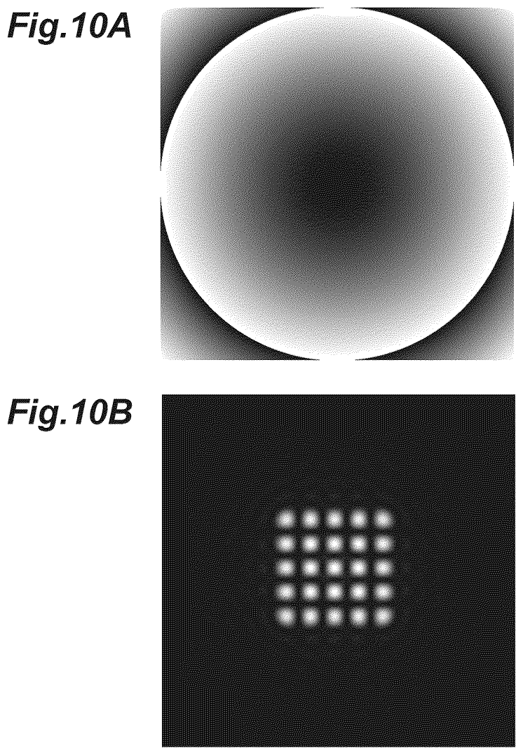

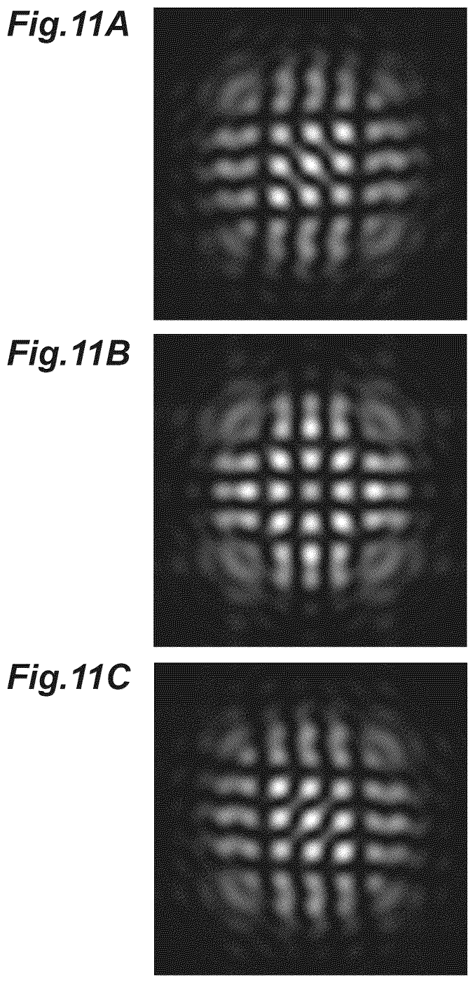

FIG. 10A is a diagram showing an example of a phase distribution by a defocus aberration of the optical system 12. FIG. 10B is a diagram showing an example of an intensity image which is formed on the output plane P2 in the case in which the optical system 12 does not have the aberration. FIG. 11A to FIG. 11C are diagrams each showing an example of the intensity image which is formed on the output plane P2 in the case in which the optical system 12 has the aberration. As shown in these diagrams, when the optical system 12 has the aberration, the image formed on the output plane P2 is distorted.

In the case in which the image formed on the output plane P2 is distorted due to the aberration of the optical system 12, the robustness of the hologram can be improved by using the following configuration. In the following description, the differences from the hologram generation method which is described with reference to FIG. 2 and FIG. 3 will be described.

In the pattern setting step S1, the pattern setting unit 21 sets the candidate pattern Φ(x, y) which is to be the candidate of the hologram presented on the input plane P1, and in addition, generates a distortion added pattern Φ_{ϵ}(x, y) obtained by adding a distortion pattern ϵ(x, y) to the candidate pattern Φ(x, y) (the following Formula (11)).

$$\begin{matrix}[ Formula 11 ] & \\ {Φ}_{ε} ( x , y ) = Φ ( x , y ) + ε ( x , y ) & ( 11 )\end{matrix}$$

In the intensity image calculation step S2, the intensity image calculation unit 22 generates the candidate intensity image I(p, q) on the output plane P2 based on the candidate pattern Φ(x, y) (the above Formula (1) to Formula (3)), and in addition, performs the following processing.

The intensity image calculation unit 22 obtains, by the calculation, the complex amplitude distribution g_{ϵ}(x, y) acquired by the laser light illumination in the case in which the distortion added pattern Φ_{ϵ}(x, y) is presented on the input plane P1 (the following Formula (12)), and performs the zero padding on the complex amplitude distribution g_{ϵ}(x, y). In addition, the intensity image calculation unit 22 performs the propagation calculation of the complex amplitude distribution g_{ϵ}(x, y) after performing the zero padding to obtain a complex amplitude distribution h_{ϵ}(p, q) on the output plane P2 (the following Formula (13)), and then generates a distortion added intensity image I_{ϵ}(p, q) on the output plane P2 (the following Formula (14)).

$$\begin{matrix}[ Formula 12 ] & \\ {g}_{ε} ( x , y ) = a ( x , y ) \cdot exp ( i {Φ}_{ε} ( x , y ) ) & ( 12 )\end{matrix}$$

$$\begin{matrix}[ Formula 13 ] & \\ {h}_{ε} ( p , q ) = F [ {g}_{ε} ( x , y ) ] & ( 13 )\end{matrix}$$

$$\begin{matrix}[ Formula 14 ] & \\ {I}_{ε} ( p , q ) = {\vert {h}_{ε} ( p , q ) \vert}^{2} & ( 14 )\end{matrix}$$

In the evaluation value calculation step S3, the evaluation value calculation unit 23 obtains the evaluation value based on the intensity correlation between the candidate intensity image I(p, q) and the target intensity image T(p, q) and an intensity correlation between the distortion added intensity image I_{ϵ}(p, q) and the target intensity image T(p, q).

The evaluation value described above may be a weighted sum of the evaluation value f (the above Formula (4)) based on the intensity correlation between the candidate intensity image I(p, q) and the target intensity image T(p, q), and the evaluation value fe based on the intensity correlation between the distortion added intensity image I_{ϵ}(p, q) and the target intensity image T(p, q) (the following Formula (15)). In addition, the respective weight values w₁ and w₂ may be equal to each other.

$$\begin{matrix}[ Formula 15 ] & \\ {w}_{1} f + {w}_{2} {f}_{ε} & ( 15 )\end{matrix}$$

In addition, in this case, the evaluation value is not limited to the evaluation value of the intensity correlation type, and further, the evaluation value of the amplitude correlation type may be used, and the evaluation value of the residual sum of squares type may be used. Further, the distortion pattern ϵ(x, y) may be only one distortion pattern, or may be a plurality of distortion patterns.

The update determination step S4, the pattern storage step S5, and the convergence determination step S6 are processes which are similar to those of the hologram generation method described with reference to FIG. 2 and FIG. 3.

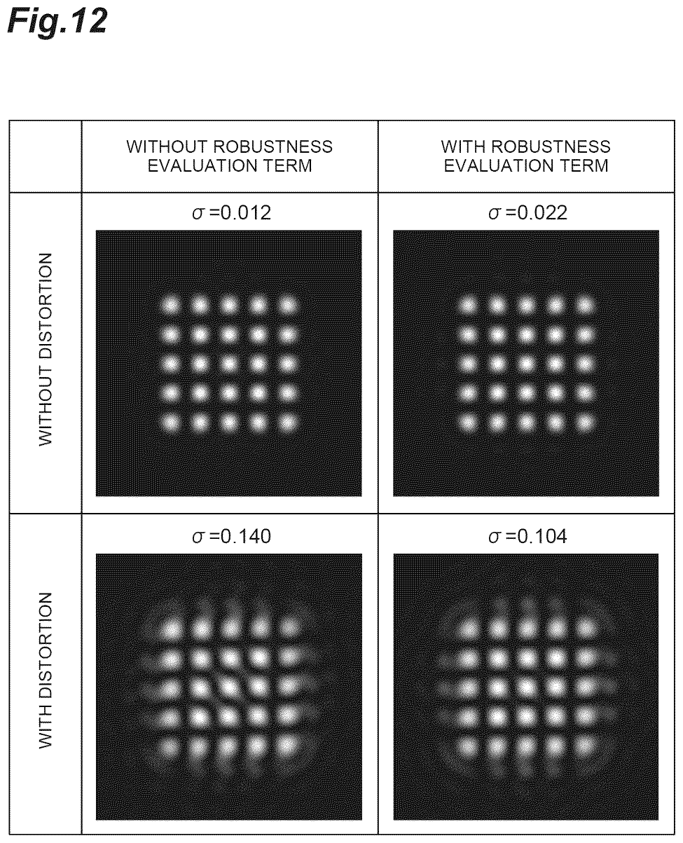

FIG. 12 is a diagram showing the images which are formed on the output plane P2 in the simulation performed with respect to the improvement of the robustness. In the diagram, σ indicates the variation (relative standard deviation) of the intensities of the focusing regions (the focusing spots) on the output plane P2. In the case in which the optical system 12 has the distortion, the variation σ of the intensities of the focusing regions is improved from 0.140 to 0.104 by considering the distortion pattern ϵ(x, y) as described above.

The hologram generation method, the hologram generation apparatus, and the light irradiation apparatus are not limited to the embodiments and configuration examples described above, and various modifications are possible.

The hologram generation method of a first aspect according to the above embodiment is a method for generating a hologram to be presented on an input plane in order to form a target intensity image on an output plane by optically propagating a complex amplitude distribution of light on the input plane, and includes (1) a pattern setting step of setting a candidate pattern to be a candidate of the hologram; (2) an intensity image calculation step of performing zero padding on a complex amplitude distribution acquired when the candidate pattern is presented on the input plane, and generating a candidate intensity image based on a result of a propagation calculation of the complex amplitude distribution after the zero padding; and (3) an evaluation value calculation step of obtaining an evaluation value based on an intensity correlation between the candidate intensity image and the target intensity image, and (4) by using an optimization method, while changing the candidate pattern set in the pattern setting step, respective processes of the pattern setting step, the intensity image calculation step, and the evaluation value calculation step are repeatedly performed, and any one candidate pattern is selected as a hologram to be presented on the input plane based on the evaluation value obtained in the evaluation value calculation step.

In the hologram generation method of a second aspect, in the configuration of the first aspect, in the pattern setting step, a distortion added pattern may be generated by adding a distortion pattern to the candidate pattern, in the intensity image calculation step, the zero padding may be performed on a complex amplitude distribution acquired when the distortion added pattern is presented on the input plane, and a distortion added intensity image may be generated based on a result of a propagation calculation of the complex amplitude distribution after the zero padding, and in the evaluation value calculation step, the evaluation value may be obtained based on the intensity correlation between the candidate intensity image and the target intensity image and an intensity correlation between the distortion added intensity image and the target intensity image.

In the hologram generation method of a third aspect, in the configuration of the first or second aspect, the target intensity image may be an image including one or a plurality of focusing regions on the output plane.

The program according to the above embodiment is a program for causing a computer to execute the respective steps of the hologram generation method of the above configuration.

The recording medium according to the above embodiment is a computer readable recording medium recording the program of the above configuration.

The hologram generation apparatus of a first aspect according to the above embodiment is an apparatus for generating a hologram to be presented on an input plane in order to form a target intensity image on an output plane by optically propagating a complex amplitude distribution of light on the input plane, and includes (1) a pattern setting unit for setting a candidate pattern to be a candidate of the hologram; (2) an intensity image calculation unit for performing zero padding on a complex amplitude distribution acquired when the candidate pattern is presented on the input plane, and generating a candidate intensity image based on a result of a propagation calculation of the complex amplitude distribution after the zero padding; and (3) an evaluation value calculation unit for obtaining an evaluation value based on an intensity correlation between the candidate intensity image and the target intensity image, and (4) by using an optimization method, while changing the candidate pattern set by the pattern setting unit, respective processes of the pattern setting unit, the intensity image calculation unit, and the evaluation value calculation unit are repeatedly performed, and any one candidate pattern is selected as a hologram to be presented on the input plane based on the evaluation value obtained by the evaluation value calculation unit.

In the hologram generation apparatus of a second aspect, in the configuration of the first aspect, the pattern setting unit may generate a distortion added pattern by adding a distortion pattern to the candidate pattern, the intensity image calculation unit may perform the zero padding on a complex amplitude distribution acquired when the distortion added pattern is presented on the input plane, and may generate a distortion added intensity image based on a result of a propagation calculation of the complex amplitude distribution after the zero padding, and the evaluation value calculation unit may obtain the evaluation value based on the intensity correlation between the candidate intensity image and the target intensity image and an intensity correlation between the distortion added intensity image and the target intensity image.

In the hologram generation apparatus of a third aspect, in the configuration of the first or second aspect, the target intensity image may be an image including one or a plurality of focusing regions on the output plane.

The light irradiation apparatus according to the above embodiment includes (1) the hologram generation apparatus of the above configuration, (2) a laser light source for outputting laser light; (3) a spatial light modulator for spatially modulating and outputting the laser light output from the laser light source based on the hologram generated by the hologram generation apparatus; and (4) an optical system for propagating a complex amplitude distribution of the laser light output from the spatial light modulator to form an image on the output plane.

The embodiments can be used as a hologram generation method and a hologram generation apparatus for generating a hologram capable of generating a target intensity image of high resolution with high accuracy, and further, a light irradiation apparatus capable of generating a target intensity image of high resolution with high accuracy.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A hologram generation method for generating a hologram to be presented on an input plane in order to form a target intensity image on an output plane by optically propagating a complex amplitude distribution of light on the input plane, the method comprising:
performing a pattern setting of setting a candidate pattern to be a candidate of the hologram;
performing an intensity image calculation of performing zero padding on a complex amplitude distribution acquired when the candidate pattern is presented on the input plane, and generating a candidate intensity image based on a result of a propagation calculation of the complex amplitude distribution after the zero padding; and
performing an evaluation value calculation of obtaining an evaluation value based on an intensity correlation between the candidate intensity image and the target intensity image, wherein
by using an optimization method, while changing the candidate pattern set in the pattern setting, respective processes of the pattern setting, the intensity image calculation, and the evaluation value calculation are repeatedly performed, and any one candidate pattern is selected as a hologram to be presented on the input plane based on the evaluation value obtained in the evaluation value calculation.

2. The hologram generation method according to claim 1, wherein
in the pattern setting, a distortion added pattern is generated by adding a distortion pattern to the candidate pattern,
in the intensity image calculation, the zero padding is performed on a complex amplitude distribution acquired when the distortion added pattern is presented on the input plane, and a distortion added intensity image is generated based on a result of a propagation calculation of the complex amplitude distribution after the zero padding, and
in the evaluation value calculation, the evaluation value is obtained based on the intensity correlation between the candidate intensity image and the target intensity image and an intensity correlation between the distortion added intensity image and the target intensity image.

3. The hologram generation method according to claim 1, wherein the target intensity image is an image including one or a plurality of focusing regions on the output plane.

4. A program for causing a computer to execute the pattern setting, the intensity image calculation, and the evaluation value calculation of the hologram generation method according to claim 1.

5. A computer readable recording medium recording the program according to claim 4.

6. A hologram generation apparatus for generating a hologram to be presented on an input plane in order to form a target intensity image on an output plane by optically propagating a complex amplitude distribution of light on the input plane, the apparatus comprising:
a pattern setting unit configured to set a candidate pattern to be a candidate of the hologram;
an intensity image calculation unit configured to perform zero padding on a complex amplitude distribution acquired when the candidate pattern is presented on the input plane, and generate a candidate intensity image based on a result of a propagation calculation of the complex amplitude distribution after the zero padding; and
an evaluation value calculation unit configured to obtain an evaluation value based on an intensity correlation between the candidate intensity image and the target intensity image, wherein
by using an optimization method, while changing the candidate pattern set by the pattern setting unit, respective processes of the pattern setting unit, the intensity image calculation unit, and the evaluation value calculation unit are repeatedly performed, and any one candidate pattern is selected as a hologram to be presented on the input plane based on the evaluation value obtained by the evaluation value calculation unit.

7. The hologram generation apparatus according to claim 6, wherein
the pattern setting unit is configured to generate a distortion added pattern by adding a distortion pattern to the candidate pattern,
the intensity image calculation unit is configured to perform the zero padding on a complex amplitude distribution acquired when the distortion added pattern is presented on the input plane, and generate a distortion added intensity image based on a result of a propagation calculation of the complex amplitude distribution after the zero padding, and
the evaluation value calculation unit is configured to obtain the evaluation value based on the intensity correlation between the candidate intensity image and the target intensity image and an intensity correlation between the distortion added intensity image and the target intensity image.

8. The hologram generation apparatus according to claim 6, wherein the target intensity image is an image including one or a plurality of focusing regions on the output plane.

9. A light irradiation apparatus comprising:
the hologram generation apparatus according to claim 6;
a laser light source configured to output laser light;
a spatial light modulator configured to spatially modulate and output the laser light output from the laser light source based on the hologram generated by the hologram generation apparatus; and
an optical system configured to propagate a complex amplitude distribution of the laser light output from the spatial light modulator to form an image on the output plane.
